(19) United States
(12) Patent Application Publication
(10) Pub. No.: US 2004/0171497 A1
(43) Pub. Date: Sep. 2, 2004

(54) Stabilized colloidal and colloidal-like systems

(75) Inventors: Frederick B. Growcock, Houston, TX (US); James E. Friedheim, Spring, TX (US)

Correspondence Address: CONLEY ROSE, P.C., P. O. BOX 3267, HOUSTON, TX, 77253-3267, US

(73) Assignee: MASI TECHNOLOGIES, L.L.C., HOUSTON, TX

(21) Appl. No.: 10/771,087

(22) Filed: Feb. 3, 2004

Related U.S. Application Data
(60) Provisional application No. 60/444,537, filed on Feb. 3, 2003.

(51) Int. Cl. C09K 7/06

(52) U.S. Cl. 507/100

(57) ABSTRACT

The present invention generally relates to improved aerated compositions comprising stabilized colloidal or colloidal-like phases (e.g., emulsions, aphrons) and methods of using those compositions. The compositions generally comprise an oleaginous bulk phase, an aqueous minor phase, one or more surfactants, aphrons and one or more aphrons stabilizers. The compositions of the present invention are stable, having increased half-lives and are capable of being used in high pressure applications.

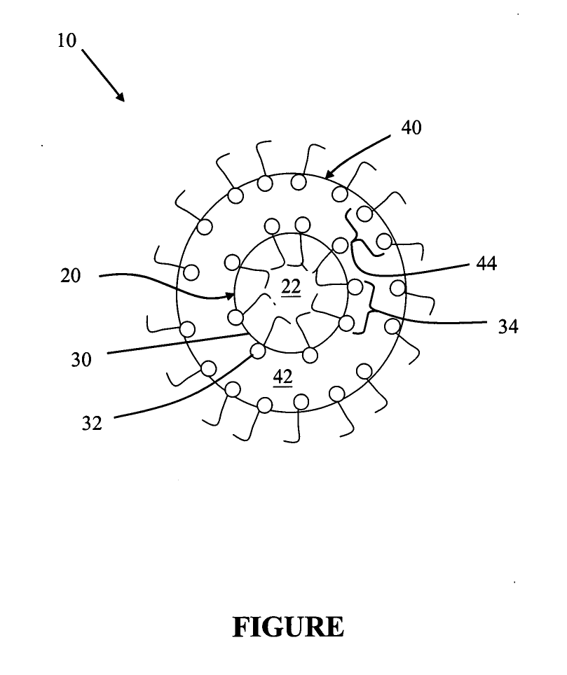

### CROSS-REFERENCE TO RELATED APPLICATIONS

This application is related to commonly assigned, co-pending U.S. Provisional Application Serial No. 60/444,537 entitled Stabilized Colloidal and Colloidal-like Systems.

### STATEMENT REGARDING FEDERALLY SPONSORED RESEARCH OR DEVELOPMENT

Not applicable.

### FIELD OF THE INVENTION

The present invention generally relates to compositions of matter and methods of using those compositions. More particularly, some of the embodiments of the present invention relate to compositions containing stabilized colloidal or colloidal-like phases (e.g., emulsions, aphrons) and methods of using such compositions.

### BACKGROUND OF THE INVENTION

Horizontal wells drilled and completed in unconsolidated sand reservoirs have become feasible recently, due to new technology and completion methods. Wells of this type require sand control, such as long open hole gravel packs or the installation of mechanical sand exclusion devices (slotted liners, prepacked screens, etc.). Successful wells have been completed with horizontal techniques, producing intervals as long as 1800 ft (550 m) and more using these methods of sand control.

Usually the wells are drilled with conventional drilling muds to the top of the pay zone, and casing is set and cemented. The cement is then drilled out to the casing shoe, and the shoe is tested. The drilling mud is then displaced with a “low-damage-potential drilling fluid” generally consisting of polymers, viscosity enhancers and particles for building a filter cake. The particles are usually graded salt (NaCl) or graded calcium carbonate (CaCO₃). These compounds are used because they are soluble in unsaturated brines or hydrochloric acid.

After the open hole interval has been drilled to total depth, the gravel pack screen or sand exclusion device is placed in the open hole interval. To do this, it becomes necessary to circulate the drilling fluid from the open hole so that the well can be gravel packed or the sand exclusion setting can be tested. Displacement of the drilling fluid with a solids-free completion brine is necessary. Concern about the physical erosion of the filter cake with the completion fluid is also always an issue. That is, the filter cake should be durable and stable enough to permit the completion or other operation to take place and protect the well bore during the entire operation.

Drilling of microfractured shales, microfractured and vugular carbonate and dolomite formations requires a drilling fluid which will seal these formations, preventing the loss of gross amounts of fluids to the formations.

The ideal drilling mud would seal all pore openings, microfractures, and the like exposed to the wellbore, stay intact during completion operations, then be easily removed by production of oil or gas. Problems arise in designing these fluids or muds because production zones vary in pressure, permeability, porosity and formation configuration. It would be desirable if fluids could be devised which would prevent the loss of expensive completion fluids to the formations and which effectively protect the original permeable formation during various completion operations such as gravel packing or well bore workovers.

Oil muds and invert emulsion (oil base) drilling fluids have found application where the use of water-based fluids would result in damage to the formation through which the drilling is progressing. For example, it is known that certain types of shale will heave and collapse if water-based drilling fluids are used. Since the oil-based drilling fluids do not result in any swelling of the shale, their use allieviates the heaving problem. Invert emulsion muds basically contain an oleaginous medium, such as hydrocarbon liquid as the continuous phase, water as the dispersed phase, various emulsifying agents, wetting agents, weighting agents and viscosifiers, such as amine treated clays.

One of the disadvantages of oil base muds is their tendency to promote lost circulation during drilling as compared to water base muds of the same density. Therefore, there exists a great need for oleaginous fluids that can rapidly seal formation fractures and/or inhibit the excessive loss of the drilling fluids. In particular, attractive oil-based fluid systems that include aphrons are described in U.S. Pat. No. 6,156,708. Additionally, other fluid based systems include aphrons, which are described in U.S. Pat. Nos. 5,881,826, 6,123,159, 6,148,917, 6,390,208 and 6,422,326 and PCT WO 98/36151.

### SUMMARY OF THE INVENTION

In accordance with the spirit of the present invention, novel fluids comprising stabilized colloidal or colloidal-like phases (e.g., emulsions, aphrons) are described herein. The fluids can be used to assist in the effective sealing of the formation. In previously known aphron-comprising oleaginous fluids, the fluids contain one or more viscosifiers, an aphron generator and some gas in the form of aphrons. The aphrons consist of a gas core which is stabilized by a thin encapsulating shell containing the aphron generator (a surfactant) and, in some embodiments, a viscosified water layer surrounded by another thin surfactant shell.

The aphron-comprising oleaginous fluids of the present invention contain the same components as previously known aphron-comprising oleaginous fluids but, in addition to those components, they also contain one or more Aphron Stabilizers and aqueous fluid in excess of the amount necessary for hydrating the viscosifiers. Without wishing to be bound by a theory, it is believed that in some embodiments the Aphron Stabilizer decreases the interfacial tension between the gas core and the surrounding aqueous layer, as well as between the aqueous layer and the oleaginous base fluid, thereby stabilizing the entire aphron structure. In other embodiments, the Aphron Stabilizer increases the viscosity of the aqueous layer to very high levels. In either case, the aphrons of the present invention display improved stability and resistance to coalescence, as compared to previously known aphrons.

Methods of use for enhanced aphron containing fluids are also described herein. For example, the fluids can be used to assist in the effective sealing of the formation. These and other embodiments of the present invention, as well as their features and advantages will become apparent with reference to the following detailed description.

### BRIEF DESCRIPTION OF THE DRAWINGS

For a more detailed understanding of the preferred embodiments of the invention, reference will now be made to the accompanying FIGURE, which is a schematic drawing of a prior art aphron.

### NOTATION AND NOMENCLATURE

In the following discussion and in the claims, the terms “including” and “comprising” are used in an open-ended fashion, and thus should be interpreted to mean “including, but not limited to . . . .” Certain terms are used throughout the following description and claims to refer to particular system components. For example, “bulk fluid” is intended to mean the fluid composition as a whole, including the oleaginous fluid and any species that may be added to it. “Bulk viscosity” is intended to refer to the viscosity, or the property of resistance to flow in the bulk fluid. “Interfacial viscosity” is intended to refer to the viscosity at the interface between two fluids in contact with each other (e.g., the viscosified water layer of an aphron and the surrounding bulk fluid). Similarly, “interfacial tension,” also known as surface tension when applied to the interface between a fluid and air, is intended to refer to the property of liquids arising from unbalanced molecular cohesive forces at or near the surface, as a result of which the surface tends to contract and has properties resembling those of a stretched elastic membrane.

In the description that follows, like parts are marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness.

### DETAILED DESCRIPTION OF THE PREFERRED EMBODIMENTS

The present invention generally relates to compositions comprising stabilized colloidal or colloidal-like phases and methods of using those compositions. Although many detailed embodiments of the present invention will be discussed herein, the fundamental idea is to provide stable, long-lasting compositions and methods for preparing and using such compositions. Some embodiments of the present invention relate to fluid compositions and methods of use of enhanced aphron containing fluids in downhole applications. In particular, it is wholly within the scope and spirit of the invention for the detailed compositions disclosed herein to be circulated in the column while drilling, logging, workover, servicing, or any other downhole operation is occurring. However, reference to downhole applications is not contemplated as the only use for the compositions of the present invention and should not be so limited. Thus, it should be appreciated that the compositions, form of the compositions, and methods of use for the compositions provided herein are only for the sake of clarity and in the interest of presenting embodiments of the present invention.

As will be shown herein, these fluids have many advantages and uses, such as assisting in the effective sealing and even rapid sealing of the formation, including sealing in high fracture or large fracture zones.

Fluid systems containing aphrons are known in the art. In general, an aphron containing drilling fluid combines the use of low shear rate viscosity generating viscosifiers with surfactants to form aphrons. The aphrons can be obtained, for example, by incorporating (1) an aphron-generating surfactant into the fluid and thereafter generating the aphrons in the fluid or (2) generating the aphrons in a liquid compatible with the fluid and mixing the two fluids together. The book by Felix Sebba entitled “Foams and Biliquid Foams—Aphrons,” John Wiley & Sons, 1987, incorporated herein by reference, is an excellent source on the preparation and properties of aphrons, i.e., microbubbles.

Referring now to the FIGURE, an aphron 10 is typically made up of a spherical core or internal phase 20, which is usually gas 22 encapsulated in a thin shell 30. This shell 30 contains surfactant molecules 32 positioned so that they produce an effective first barrier 34 against a second phase 40 comprised of viscosified water 42. Second phase 40 also contains surfactant molecules 32 positioned so that they produce an effective second shell 44 against coalescence with adjacent aphrons (not shown). Ideally, the hydrophobic portion of surfactant molecules 32 in second phase 40 extends into the bulk fluid. In summary, the gas core is stabilized by two layers of surfactant molecules and a viscosified aqueous layer. Aphron generation can be accomplished by any means known in the art, such as the methods described in the book by Felix Sebba mentioned above.

Two major components for creating stable aphrons are surfactants and viscosifiers. The surfactants are responsible for the formation of the aphrons' unique layers. These surfactants must be arranged in such a way that the aphron structure is compatible with the base liquid and the viscosifier therein such that the LSRV of the fluid can be maintained. The aphron-generating surfactant may be anionic, non-ionic, or cationic depending on compatibility with the viscosifier. Anionic surfactants include, for example, alkyl sulfates, alpha olefin sulfonates, alkyl (alcohol) ether sulfates, refined petroleum sulfonates, and mixtures thereof. Non-ionic surfactants include, for example, ethoxylated alcohols and amine oxides. Cationic surfactants include, for example, quaternary salts.

Generally, stable aphron-containing fluids are obtained by increasing the LSRV of the fluid to at least 10,000 centipoise (Brookfield viscosity at 0.06 sec⁻¹). Because the stability of the aphrons is enhanced as the LSRV increases, a LSRV of more than 100,000 centipoise may be desired. This is accomplished with appropriate viscosifiers. In general, suitable viscosifiers include organic polymers; inorganic polymers; dispersed clays; dispersed minerals; mixed metal hydroxides, oxyhydroxides and oxides; biopolymers; water-soluble synthetic polymers; other types of polymers; and mixtures thereof. Many suitable viscosifiers are listed in U.S. Pat. Nos. 5,881,826, 6,123,159, 6,148,917, 6,156,708, 6,390,208, 6,422,326 and PCT/US98/02566.

The base oleaginous liquid may be any organic, water-insoluble liquid, which can be viscosified to the desired extent. Exemplary oleaginous liquids known in the art include petroleum oils and fractions thereof, vegetable oils, and various synthetic organic liquids such as oligomers of unsaturated hydrocarbons, carboxylic acid esters, phosphoric acid esters, ethers, polyalkyleneglycols, diglymes, acetals, and the like.

The present invention provides compositions and methods of use that are an improvement over the existing aphron technology. For example, fluids in accordance with the present invention possess tougher, more resilient surfaces that allow aphrons to survive for long, extended periods of time in severe conditions (e.g., high pressure). Because of the increased stability, the enhanced aphrons are able to seal permeable zones more effectively. All of these added benefits and others can lead to reduced operating costs.

As set forth in the “Summary of the Invention,” the fluid composition in one embodiment of the present invention comprises an aphron-containing oleaginous liquid, one or more viscosifiers, an aphron generator, one or more Aphron Stabilizers, and an aqueous fluid in excess of the amount necessary for hydrating the viscosifiers. At moderate gas concentrations, the stability of bubbles in an oleaginous medium is a function primarily of bulk fluid viscosity and interfacial tension. Bulk viscosity is generally derived from polymers or polymer-like molecules, e.g., xanthan gum and/or clays. Interfacial tension is usually lowered with a surfactant. However, in contrast to a typical bubble, an aphron is stabilized by the interfacial viscosity between the second phase and the base oleaginous fluid.

It has been discovered that aphrons can be strengthened by stabilizing the viscosified water layer through incorporation of the following additives in the oleaginous system: (1) an aqueous phase (i.e., water), (2) one or more water-based viscosifiers, and (3) one or more surfactants. Ingredients (2) and (3) constitute the Aphron Stabilizer. In a preferred embodiment, the aphron-containing oleaginous system comprises: (1) an aqueous phase, (2) one or more water-based viscosifiers, (3) a surfactant to stabilize the gas/water interface, and (4) a surfactant to stabilize the water/oil interface. It should be understood that if the oleaginous liquid already contains an aqueous phase in excess of that needed to hydrate the viscosifiers, then it may not be necessary to add additional amounts of aqueous liquid to the system.

In some embodiments, the LSRV of the bulk oleaginous fluid is increased prior to incorporating a compatible Aphron Stabilizer into the fluid. Also, in some embodiments, the LSRV of the bulk fluid is preferably at least 10,000 centipoise, more preferably at least 50,000 centipoise, and still more preferably at least 100,000 centipoise.

Without wishing to be bound by a theory, it is believed that in some embodiments the Aphron Stabilizer functions as a stabilizing agent for both the gas/water interface and the water/oleaginous phase interface: the Aphron Stabilizer lowers the interfacial tension between the gas core and the surrounding water layer, as well as between the water layer and the continuous oleaginous base fluid, thereby stabilizing the entire aphron structure. In other embodiments, the water layer surrounding the gas core is strengthened by incorporating a cross-linkable polymer in it, which increases its viscosity to very high levels. In either case, the aphrons of the present invention display improved stability and resistance to coalescence as compared to previously known aphrons. Alternatively, the cross-linking stabilizers can be used in combination with the other stabilizers disclosed herein.

Suitable Aphron Stabilizers include, but are not limited to, the following compositions: Oil-Based Emulsifier, Water-Based Detergent, Lime, Cross-Linkable Polymer, Surfactant and mixtures thereof. For the preferred embodiments, the Aphron Stabilizer comprises at least 0.01% by weight of the total fluid. In one embodiment, the Aphron Stabilizer comprises from about 0.01% to about 3% of the net weight of the fluid composition, preferably from about 0.03% to 1%.

All surfactants, the gas in first phase 20, the aqueous phase 40, and any additional viscosifiers may be selected from suitable species known in the art and disclosed above. The fluid compositions may additionally contain weighting agents, corrosion inhibitors, soluble salts, biocide, fungicides, seepage loss control additives, bridging agents, deflocculants, lubricity additives, shale control inhibitors, foam suppressors, and other additives as desired.

In addition, if necessary, air or other gases can be incorporated into the fluid to entrain more gas for forming aphrons 10. The gas may be any gas, which is not appreciably soluble in the liquid phase of the fluid. For example, the gas may be air, nitrogen, carbon dioxide, organic gases, and the like, including air encapsulated in the fluid during mixing.

The aphrons 10 can be generated by any means known in the art, including the means taught by Sebba. The following “Example” section highlights the composition of the enhanced aphron system made in accordance with the present invention.

### EXAMPLE

Two bulk fluid compositions were prepared. A list of the components used is given in Table 1.

TABLE 1
Bulk Fluid Composition

| Component | Clay-based Example | Polymer-based Example |
|---|---|---|
| Base Oil (bbl) | 0.97 | 0.95 |
| Primary Viscosifier (ppb) | 15 | 6.8 |
| Secondary Viscosifier | 2 | 3.4 |
| (ppb) | | |
| Aphron Generator (ppb) | 1-6 | 2-6 |
| Water (bbl) | 0.03 | 0 |
| Additional Water (bbl) | 0.03 | 0.03 |
| Aphron Stabilizer (ppb) | 0.1 | 0.1 |

Referring to Table 1, the Base Oil for both formulations is Diesel #2. The other ingredients in the clay-based example are as follows: the primary viscosifier used is an organoattapulgite-based blend comprised of approximately 90 wt % organoattapulgite, 7.5 wt % propylene carbonate, and 7.5 wt % aluminum stearate, sold by MASI Technologies L.L.C., a joint venture between M-I L.L.C. and ActiSystems, Inc., under the tradename Tri-Vis™; the secondary viscosifier used is an organobentonite-based blend comprised of approximately 62.4 wt % organobentonite, 15.6 wt % organoattapulgite, 19.5 wt % propylene carbonate, and 2.5 wt % anti-sticking/anti-caking agent, sold by MASI Technologies L.L.C., a joint venture between M-I L.L.C. and ActiSystems, Inc., under the tradename Tri-Vis cp+™; and the aphron generator used is a clay-stabilized silicone oil comprised of approximately 66 wt % organoattapulgite, 31 wt % silicone oil, and 3 wt % anti-sticking/anti-caking agent, sold by MASI Technologies L.L.C., a joint venture between M-I L.L.C. and ActiSystems, Inc., under the tradename Micro-Dyne™. Additional water is needed for this formulation, above the level that is normally present to promote dispersion of the viscosity-producing clays. Finally, the Aphron Stabilizer is composed of 50 wt. % Polyvinyl alcohol (PVOH), trade name Celvol 540S from Celanese Corp. and 50 wt. % alkyl ether sulfate, trade name Witcolate 1259, from Akzo Nobel.

Referring still to Table 1, the composition of the ingredients in the polymer-based example is as follows: the primary viscosifier used is Kraton G1702™, sold by Kraton Polymers; the secondary viscosifier is Versapac™, sold by M-I L.L.C.; and the aphron generator used is a clay-stabilized silicone oil comprised of approximately 66 wt % organoattapulgite, 31 wt % silicone oil, and 3 wt % anti-sticking/anti-caking agent, sold by MASI Technologies L.L.C., a joint venture between M-I L.L.C. and ActiSystems, Inc., under the tradename Micro-Dyne™. As is the case for the clay-based formulation, the polymer-based formulation requires additional water. The Aphron Stabilizer is composed of 50 wt. % Polyvinyl alcohol (PVOH), trade name Celvol 540S, from Celanese Corp. and 50 wt. % alkyl ether sulfate, trade name Witcolate 1259, from Akzo Nobel.

All the components listed in Table 1 are believed to have at least one main function in the resultant fluids. For example, the Aphron Stabilizer may also be the aphron generator or aid in the generation of aphrons. Also, the water present in the clay-based formulation is believed to be the primary polar activator for proper dispersion of the organoclays; propylene carbonate acts as a secondary polar activator.

In addition to the components listed in Table 1, other additives including wetting agents, filtration control agents and defoamers, may be used if desired.

In some embodiments, one or more Aphron Stabilizers are employed. For example, a polyvinyl alcohol/surfactant blend disclosed in a co-pending application entitled “Stabilized Colloidal and Colloidal-like Systems” filed on Feb. 3, 2003, incorporated herein by reference in its entirety, may be used to further enhance the aphrons by increasing the elasticity and toughness of the viscosified water layer of the aphrons. The half-life of the aphrons is believed to be increased several fold as a result of the increase in aphron stability. In these embodiments, additional water in the formulations may work synergistically with the Aphron Stabilizer(s) to provide even greater aphron strength.

Aphron generation was accomplished by entraining air under ambient conditions with a Silverson LV-4 mixer with disintegrator head rotating at 7000 rpm for 6 min. Alternatively, the aphrons can be generated using the procedures and equipment taught by Sebba in U.S. Pat. No. 3,900,420 and Donald Michelsen in U.S. Pat. No. 5,314,644. The fluid containing the aphrons can then be continuously directed to a desired location.

The quantity of aphrons in the fluids may be determined from the % Entrained Air in the fluid, which in turn is determined from the relative density of the bulk fluid d₀ compared to its gas-free theoretical density dₜ:

% Entrained Air=[(dₜ−d₀)/dₜ]×100

The quantity of aphrons desired in the fluids depends on the ultimate function of the aphrons. In some embodiments, the concentration of aphrons that is desired in the fluid is approximately from about 5% by volume to about 25% by volume, preferably from about 10% by volume to about 20% by volume. The quantity of aphrons in the fluids may be controlled by using more or less aphron generator and Aphron Stabilizer. The density of the bulk fluid can be monitored and additional aphron generator and Aphron Stabilizer added as necessary to maintain the desired quantity of aphrons. In one embodiment, the present invention is intended to help prevent the loss of circulating fluid into the formation by incorporating the enhanced aphrons into a drilling or servicing fluid or any other type of downhole fluid. The present invention is not limited to any particular formation zone. The embodiments of the invention can be useful for promoting sealing of all types of formation zones where fluid can be lost. For example, the present invention can be useful in sealing or enhancing sealing of formation fractures. As noted above, formation fractures vary in size and shape from microscopic to small caves. For smaller fractures, i.e., about 10 μm or less, normal drilling fluid sealants can be effective, but the present invention may be used as an enhancement to strengthen, stabilize or reduce the time necessary to build the plug.

Because the aphrons have a low density, they will reduce the net density of the fluids they are in at ground level and will tend to float in most fluids. Thus, it is critical to keep the aphrons adequately mixed or agitated during preparation while traveling through the drillstring. Mixing and agitation is accomplished through any means known in the art.

In addition to or in place of agitation or mixing and/or dilution, an additive can be incorporated into the bulk fluid that helps maintain uniform distribution of the aphrons. Additives can also help maintain pumpability of the fluid. The more preferred additives are viscosifiers. Suitable viscosifiers are limited only by their compatibility with the base fluid and the aphrons and should exhibit LSRV and/or suspension properties. For example, in oleaginous based fluids, any oil-soluble or oil-dispersible viscosifier would suffice, e.g., organophilic clays, viscoelastic surfactants, polymers or other like chemicals. In a preferred embodiment, a blend of organophilic clays is added to the fluid. The preferred clays according to the present invention comprise attapulgites and bentonites.

Also provided herein are methods of using the above-mentioned compositions. In one embodiment, a fluid composition comprising an oleaginous liquid, one or more viscosifiers, aphrons, one or more Aphron Stabilizers, and an aqueous fluid in excess of the amount necessary for hydrating the viscosifiers, is pumped downhole at elevated pressures, e.g., 2,000+ psi, using a cavitating pump. The aphrons are formed from entrained air acquired in the mud tanks above ground or dissolved gas in the fluid composition. The aphrons of the present invention are stable even under elevated pressures of greater than or equal to about 2,000 psi, preferably stable at pressures of greater than or equal to about 5,000 psi, and more preferably stable at pressures of greater than or equal to about 8,000 psi.

During drilling, the aphrons are compressed due to the excess pressure of the column, and the aphrons enter the formation fractures. The pressure is less within the fractures allowing the aphrons to expand. The expansion of the aphrons, coupled with their aggregation within the fracture, can effectively fill and seal the fracture. The enhanced aphrons preferably have a half-life of greater than or equal to about 5 hours, more preferably have a half-life of greater than or equal to about 10 hours, and still more preferably have a half-life of greater than or equal to about 15 hours.

Half-life is herein defined as the length of time that must pass for half of the entrained air to leave a fluid sample in an open cup at room temperature and pressure and is measured from the difference in initial density (immediately after entraining air as described above) and after 3 hr:

T_{1/2}(hr)=2.08 ln⁻¹[% Air_{3 hr}/% Airᵢₙᵢₜᵢₐₗ]

In some embodiments, a fluid containing aphrons which enters the formation is clean and essentially solids-free, such that damage to the formation is significantly less than with solids-containing fluids.

In addition, while the use of the Aphron Stabilizer has been discussed in terms of aphron-containing systems, it is fully within the scope of the invention to use the Aphron Stabilizer in any drilling fluid-or other colloidal suspension to encapsulate, stabilize, or protect in situ various products, including lubricants, spotting fluids, detergents, drilling enhancers, corrosion inhibitors, polymer breakers, fluid loss additives, polymer cross-linkers, etc. It is contemplated that products stabilized with the Aphron Stabilizer may be able to specifically associate with a target surface and that mechanical, thermal, or chemical forces may permit the product to be disgorged at the target surface, thereby performing an enhanced effect of the product. For example, lubricant droplets could be encapsulated using the Aphron Stabilizer, enabling the droplets to reach and attach themselves to drillpipe and casing, where high shear and compressive forces between the drillpipe and casing rupture the aphron stabilized-shell and disgorge the lubricant directly onto the drillpipe and casing surfaces. This contemplated use is a vast improvement over conventional technology, where a large amount of lubricant has to be continuously applied to a mud system because (1) the lubricant becomes tightly emulsified as the mud circulates and therefore does not adsorb easily, and (2) what lubricant does not become tightly emulsified adsorbs on all surfaces regardless of composition.

Also, the Aphron Stabilizer itself may provide some functionality as a lubricant, spotting fluid, shale inhibitor, wellbore stabilizer, etc. The Aphron Stabilizer may additionally be able to protect cuttings generated during the drilling process, thereby reducing dispersion of the cuttings and enabling the cuttings to be removed from the mud system more easily.

While preferred embodiments of this invention have been shown and described, modification thereof can be made by one skilled in the art without departing from the spirit or teaching of this invention. The embodiments described herein are exemplary only and are not limiting. Many variations and modifications of the compositions and methods are possible and are within the scope of this invention. For example, it is completely within the spirit and scope of the present invention for the various fluid compositions described herein to be mixtures of each other. Accordingly, the scope of protection is not limited to the embodiments described herein, but is only limited by the claims, the scope of which shall include all equivalents of the subject matter of the claims.

What is claimed is:

1. A drilling or servicing fluid composition comprising:
an oleaginous liquid as the continuous phase;
one or more surfactants;
aphrons; and
one or more aphron stabilizers, wherein at least one of said aphron stabilizers produces an average aphron half-life of greater than or equal to about 5 hours.

2. The composition according to claim 2 wherein at least one of the aphron stabilizers is selected from the group consisting of emulsifiers, detergents, lime, polymers, surfactants and mixtures thereof.

3. The composition according to claim 1 wherein the composition comprises at least 0.01% by weight aphron stabilizer.

4. The composition according to claim 1 wherein the composition comprises from about 0.01% to about 3% by weight aphron stabilizer.

5. The composition according to claim 1 wherein the composition comprises from about 0.03% to about 1% by weight aphron stabilizer.

6. The composition according to claim 1 wherein said oleaginous liquid comprises an organic, water-insoluble liquid.

7. The composition according to claim 6 wherein said oleaginous liquid is selected from the group consisting of petroleum oils and fractions thereof, vegetable oils, and synthetic organic liquids.

8. The composition according to claim 1 wherein at least one of the surfactants is selected from the group consisting of anionic, non-ionic and cationic surfactants.

9. The composition according to claim 1 further comprising one or more viscosifiers.

10. The composition according to claim 9 wherein said one or more viscosifiers is selected from the group consisting of oil-soluble and oil-dispersible viscosifiers.

11. The composition according to claim 9 wherein said one or more viscosifiers is selected from the group consisting of organophilic clays, viscoelastic surfactants, polymers and mixtures thereof.

12. The composition according to claim 11 wherein said one or more viscosifiers comprises an organophilic clay selected from the group comprising attapulgites, bentonites, and mixtures thereof.

13. The composition according to claim 9 further comprising aqueous fluid in excess of an amount sufficient to hydrate said one or more viscosifiers.

14. The composition according to claim 13 wherein there is a synergistic effect between said excess aqueous fluid and aphron stabilizer.

15. The composition according to claim 1 further comprising one or more additives selected from the group consisting of weighting agents, corrosion inhibitors, water-soluble salts, biocide, fungicides, seepage loss control additives, bridging agents, deflocculants, lubricity additives, shale control inhibitors, foam suppressors, emulsifying agents, wetting agents, filtration control agents, and mixtures thereof.

16. The composition according to claim 1 wherein the composition has a low shear rate viscosity as measured by a Brookfield Viscometer at 0.06 sec⁻¹ of at least 10,000 centipoise.

17. The composition according to claim 1 wherein the composition has a low shear rate viscosity as measured by a Brookfield Viscometer at 0.06 sec⁻¹ of at least 20,000 centipoise.

18. The composition according to claim 1, wherein the composition has a low shear rate viscosity as measured by a Brookfield Viscometer at 0.06 sec⁻¹ of at least 50,000 centipoise.

19. The composition according to claim 1 wherein the composition has a low shear rate viscosity as measured by a Brookfield Viscometer at 0.06 sec⁻¹ of at least 100,000 centipoise.

20. The composition according to claim 1 wherein the aphrons comprise from about 5% by volume to about 25% by volume of the composition.

21. The composition according to claim wherein the aphrons comprise from about 10% by volume to about 20% by volume of the composition.

22. The composition according to claim 1 wherein the aphrons have an average half-life of greater than or equal to about 10 hours.

23. The composition according to claim 1 wherein the aphrons have an average half-life of greater than or equal to about 15 hours.

24. The composition according to claim 1 wherein the aphrons are stable at pressures of greater than or equal to about 2,000 psi.

25. The composition according to claim 1 wherein the aphrons are stable at pressures of greater than or equal to about 5,000 psi.

26. The composition according to claim 1 wherein the aphrons are stable at pressures of greater than or equal to about 8,000 psi.

27. The composition according to claim 1 wherein the composition can be continuously recirculated.

28. The composition according to claim 1 wherein the aphrons prevent loss of excess drilling or servicing fluid into a formation.

29. The composition according to claim 1 wherein the aphrons effectively seal a formation.

30. A process for drilling or servicing a wellbore in a subterranean formation wherein a drilling or servicing fluid is circulated in the wellbore, comprising:
utilizing as the drilling or servicing fluid an oleaginous liquid as the continuous phase, one or more surfactants, aphrons, and one or more aphron stabilizers, wherein at least one of said aphron stabilizers produces an average aphron half-life of greater than or equal to about 5 hours.

31. The process according to claim 30 wherein the aphrons have an average half-life of greater than or equal to about 10 hours.

32. The process according to claim 30 wherein the aphrons have an average half-life of greater than or equal to about 15 hours.

33. The process according to claim 30 wherein the composition can be continuously recirculated.

34. The process according to claim 30 wherein the aphrons prevent loss of excess drilling or servicing fluid into the formation.

35. A drilling or servicing fluid composition comprising:
an oleaginous liquid as the continuous phase;
one or more surfactants;
aphrons;
one or more aphron stabilizers
one or more viscosifiers; and
aqueous fluid in excess of an amount sufficient to hydrate said one or more viscosifiers.

36. The composition according to claim 35 wherein there is a synergistic effect between said excess aqueous fluid and aphron stabilizer.

37. The composition according to claim 36 wherein said one or more viscosifiers comprises an organophilic clay selected from the group comprising attapulgites, bentonites, and mixtures thereof.

38. The composition according to claim 37 wherein the composition comprises at least 0.01% by weight aphron stabilizer.

39. The composition according to claim 38 wherein the aphrons have an average half-life of greater than or equal to about 10 hours.

40. The composition according to claim 38 wherein the aphrons have an average half-life of greater than or equal to about 15 hours.
